(19) United States
(12) Patent Application Publication
(10) Pub. No.: US 2004/0126009 A1
(43) Pub. Date: Jul. 1, 2004

(54) Image processing apparatus, image processing method, and image processing program

(76) Inventors: Hirokazu Takenaka, Kanagawa (JP); Hisao Shirasawa, Kanagawa (JP); Yuki Matsushima, Kanagawa (JP)

Correspondence Address: Ivan S. Kavrukov, Esq., Cooper & Dunham LLP, 1185 Avenue of the Americas, New York, NY, 10036, US

(21) Appl. No.: 10/666,422

(22) Filed: Sep. 18, 2003

(30) Foreign Application Priority Data
Sep. 19, 2002 (JP) 2002-274153
Nov. 29, 2002 (JP) 2002-346625

(51) Int. Cl. G06K 9/00

(52) U.S. Cl. 382/162

(57) ABSTRACT

An image processing apparatus, which includes an input unit inputting a color signal of a color space, a designating unit designating a color range according to the input color signal, a black amount determining unit determining an amount of black for the input color signal by referring to a black generation condition corresponding to the designated color range, wherein the designated color area is an area where a difference between a maximum amount of black and a minimum amount of black is small.

### BACKGROUND OF THE INVENTION

1. Field of the Invention

The present invention relates to an image processing apparatus, an image processing method, and an image processing program for outputting a color image with color signal elements of C, M, Y, K according to color data independent from an input apparatus, and more particularly, to an image processing apparatus, an image processing method, and an image processing program for suitably generating black (K). The present relation also relates to an image processing method and an image processing apparatus executing the image processing method for converting a color signal, being input to a color image forming apparatus such as an electrophotographic type image forming apparatus, into a color material signal.

2. Description of the Related Art

Conventionally, a color conversion process for color printers was performed typically by converting device-dependent color signals (R, G, B), which are dependent to a display device (display), into density signals (C, M, Y), and, then, converting the density signals to device signals (C′, M′, Y′, K′) dependent to a printer.

A K′ signal is generated by replacing overlapped (C, M, Y) with K′. K′ is expressed as given below.

K′=α×min (C,M,Y)

(C′,M′,Y′) can be respectively expressed with K′ as follows.

C′=C−βK′

M′=M−βK′

Y′=Y−βK′

α and β are values optimized for respective printers with account for image degrading factors such as granularity and gray balance.

However, as exchanging of data via a network increases, another method is gaining recognition, in which the method converts device-dependent color signals (RGB), which are dependent to display devices or the like, into device-independent signals (uniform color space such as L*,a*,b* or X,Y,Z) and then converts the device-independent signals into device-dependent signals (C′,M′,Y′) dependent to output apparatuses or the like.

The uniform color space has gained recognition due to difficulty in obtaining color properties of output apparatuses according to signals with color properties of display devices, and also to difficulty in achieving versatility of color conversion.

As methods for obtaining K′ (hereinafter referred to as “black”) with uniform color space, the following technologies have been disclosed.

In Japanese Laid-Open Publication No.11-225279, a maximum value of black and a minimum value of black in a uniform color space are computed, and then, an actual value of black is computed by using the computed maximum value of black, the computed minimum value of black, and a plurality of parameters. The parameters are determined by lightness and chromaticness.

Japanese Laid-Open Publication No.2001-86360 discloses a technology of obtaining a value of black (K′) in a Lab plane: wherein a standard black value (K0) according to a lightness component is computed; then, an adjustment coefficient (β) (≦1) is computed according to a chromaticness component and a color hue component; and then, multiplying the standard black value with the adjustment coefficient (K′=β×K0). Remaining color components (C′, M′, Y′) are calculated with (L, a, b, K′).

With the technology disclosed in Japanese Laid-Open Publication No.11-225279, the computed value of black always falls within a range between the maximum value of black and the minimum value of black owing to the fact that the appropriate value of black is computed by using the maximum value of black and the minimum value of black. Nevertheless, the technology is unable to provide consecutive values of black unless the maximum value of black and the minimum value of black are computed with precision. Furthermore, with this technology, the range of gamut has priority over granularity under high chromaticness.

With the technology disclosed in Japanese Laid-Open Publication No.2001-86360, consecutiveness of black can be guaranteed and granularity can be adjusted easily. Nevertheless, with this technology, adjusting the optimum value of black to fall within the range between the maximum value of black and the minimum value of black is difficult, and the range of the value of black may become narrower than the gamut that a printer is able to provide.

From another aspect, four colors of yellow (Y), magenta (M), cyan (C), and black (K) are commonly used for color printing color images with an electrophotographic method or the like. Meanwhile, color signals such as device-independent signals (e.g. L*a*b* signals, L*u*v* signals) or display device-dependent signals (e.g. RGB signals) are color signals in three dimensional color spaces. Therefore, in color printing the color images, the color signals in the three dimensional color space are required to be converted for a four dimensional color space. Nevertheless, since the conversion is a conversion between different dimensions, color signals for each of the dimensions do not correspond to each other in a one to one manner. Therefore, the color images in the three dimensional color space can be made to correspond to the color signals in the four dimensional space in a variety of combinations.

Determining which of the four color signals to be used depends on circumstance and certain conditions. For example, in a case where four colors for generating a maximum amount of K (amount of black) are selected, there may be a benefit of requiring only a small amount of color material. On the other hand, graininess of K may be excessively noticeable in a state under highlight, and may therefore require less amounts of K for providing high quality images.

In addition to four colors of YMCK, some inkjet type printers or the like employ high/low density inks, for example, light cyan ink(LC) or light magenta ink (LM) (which are inks of same color but have less color density with respect to C and M) so as to enhance the quality of images. Since there is a degree of freedom in regarding the proportion of such high/low density inks to be used, the proportion of such high/low density inks is also determined from conditions such as amount of color material or graininess.

One example of a technology for suitably determining an optimum amount or proportion of black (high/low density ink) is disclosed in Japanese Laid-Open Patent Application No.2002-33930. This example uses a table for separating colors into color material colors, to thereby determine a suitable amount of black (or amount of high/low density ink) per hue. In creating the table, a line extending between white and black, and lines extending between black and primary and/or secondary colors are defined to thereby determine an amount of black within a color reproduction range according to the lines. Furthermore, amount of black is determined according to a line of maximum color range and an achromatic line to thereby perform interpolation with respect to an area inside the color reproduction range.

In another technology disclosed in Japanese Laid Open Patent Application No.2002-10096, a YMCK modeling portion, a black adjustment computing portion, a black limit computing portion, and an optimum black modeling portion employ a plurality of color signals (which are included in a partial color space that can be expressed by at least three colors and four colors including black, and thus are situated on a curved plane satisfying a coverage limit) as representative signals to thereby perform modeling between the representative signals and a corresponding optimum black amount. Based on the model, an optimum black determining portion predicts an optimum amount of black with respect to a color signal of an input color space, and a YMCK color signal computation portion predicts three colors except black according to an input color signal and the predicted optimum amount of black.

Nevertheless, merely defining an amount of black (or amount of high/low density ink) per hue is insufficient for defining an optimum amount of black (or amount of high/low density ink) for an entire color range.

For example, graininess tends to be noticeable for a color range typically referred to as memory color (e.g. human skin color). In a case where suitable graininess is desired for the memory color range, the amount of black (or amount of high/low density ink) for the memory color is preferred to be defined separately from defining the amount of black for other color ranges. Nevertheless, this cannot be achieved by merely using the maximum color range line and the achromatic line.

In another case, for example, there may be a necessity to increase the amount of black for an area proximal to an achromatic axis in order to enhance the gray balance thereat. Nevertheless, a suitable amount of black for a local area (such as the area proximal to the achromatic axis) cannot be obtained merely by interpolation with use of the achromatic line and the maximum color range line.

### SUMMARY OF THE INVENTION

It is a general object of the present invention to provide an image processing apparatus, an image processing method, and an image processing program that substantially obviate one or more of the problems caused by the limitations and disadvantages of the related art.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by an image processing apparatus, an image processing method, and an image processing program particularly pointed out in the specification in such full, clear, concise, and exact terms as to enable a person having ordinary skill in the art to practice the invention.

To achieve these and other advantages and in accordance with the purpose of the invention, as embodied and broadly described herein, the invention provides an image processing apparatus, including: an input unit inputting a color signal of a color space; a designating unit designating a color range according to the input color signal; a black amount determining unit determining an amount of black for the input color signal by referring to a black generation condition corresponding to the designated color range, wherein the designated color range is a range where a difference between a maximum amount of black and a minimum amount of black is small. Accordingly, while being able to maintain a gamut of maximum range, a continuous amount of black can be obtained and thus adjustment of amount of black can be performed easily with respect to image degrading factors.

In the image processing apparatus of the present invention, the color signal of the color space may include components of lightness, chroma, and hue. Accordingly, adjustment with account for image degrading factor and computation of black can be performed easily.

In the image processing apparatus of the present invention, the designated color range may be situated on a line passing through a basing point and a maximum chroma point, wherein the black generation condition defines a black generation function according to the maximum amount of black and the minimum amount of black of the designated color range. Accordingly, a gamut of maximum range can be obtained.

In the image processing apparatus of the present invention, the basing point may be a black point. Accordingly, adjustment with account for image degrading factor and computation of black can be performed easily.

In the image processing apparatus of the present invention, the black generation function may be inputted with a value of a distance between the basing point and the input color signal. Accordingly, adjustment with account for image degrading factor and computation of black can be performed easily.

In the image processing apparatus of the present invention, when a black starting point situated on the line passing through the basing point and the maximum chroma point is Si, and when another black starting point situated on a line passing through the basing point and a white point is Li, the black amount determining unit may determine the amount of black according to the black generation condition, and coordinates for the basing point, Si, Li, and the input color signal. Accordingly, a gamut of maximum range can be obtained and thus a continuous black amount can be computed.

In the image processing apparatus of the present invention, the black amount determining unit may determine the amount of black by normalizing the black generation function according to the input color signal. Accordingly, a gamut of maximum range can be obtained and thus a continuous black amount can be computed.

In the image processing apparatus of the present invention, Si and Li may be designated according to a factor leading to image degrading. Accordingly, image quality can be enhanced.

In the image processing apparatus of the present invention, Si and Li may be designated according to a range of a prescribed color. Accordingly, graininess for a prescribed color (memory color) can be enhanced.

In the image processing apparatus of the present invention, Si and Li may be designated according to a characteristic of an output apparatus. Accordingly, adjustment can be made with respect to image degrading factors caused by an output apparatus.

In the image processing apparatus of the present invention, Si may be designated according to the hue of the input color signal. Accordingly, graininess can be adjusted according to hue.

In the image processing apparatus of the present invention, Si may be designated according to a length of a line connecting the basing point and the maximum chroma point. Accordingly, graininess can be easily adjusted according to hue.

In the image processing apparatus of the present invention, Si may be designated according to black starting point data for hues of Red, Green, Blue, Cyan, Magenta, and Yellow. Accordingly, graininess can be easily adjusted according to hue.

An image processing method including the steps of: a) inputting a color signal of a color space; b) designating a color range according to the input color signal; and c) determining an amount of black for the input color signal by referring to a black generation condition corresponding to the designated color range, wherein the designated color range is a range where a difference between a maximum amount of black and a minimum amount of black is small. Accordingly, while being able to maintain a gamut of maximum range, a continuous amount of black can be obtained and thus adjustment of amount of black can be performed easily with respect to image degrading factors.

An image processing method comprising the steps of: a) inputting a color signal of a color space; b) designating a color range according to the input color signal; c) determining an amount of black for the input color signal by referring to a black generation condition corresponding to the designated color range; and d) creating a table indicative of the amount of black determined in step c), wherein the designated color range is a range where a difference between a maximum amount of black and a minimum amount of black is small. Accordingly, while being able to maintain a gamut of maximum range, a continuous amount of black can be quickly obtained and thus adjustment of amount of black can be performed easily with respect to image degrading factors.

A program recorded to be executed with an image processing apparatus, including the steps of: a) inputting a color signal of a color space; b) designating a color range according to the input color signal; and c) determining an amount of black for the input color signal by referring to a black generation condition corresponding to the designated color range, wherein the designated color range is a range where a difference between a maximum amount of black and a minimum amount of black is small. Accordingly, while being able to maintain a gamut of maximum range, a continuous amount of black can be obtained and thus adjustment of amount of black can be performed easily with respect to image degrading factors.

An image processing method for converting a color signal, being input to an image output apparatus, into a color material signal, the image processing method including the steps of: defining a first line, defining one or more second lines, allocating one or more color material signals on the first and second lines, and obtaining a color material signal situated between the first and second lines by interpolation according to the first and second lines. Accordingly, a color material signal (especially amount of black) can be suitably and simply determined (obtained) for a prescribed range without having to refer to an outermost boundary line.

In the image processing method of the present invention, the first line may be an achromatic line in a reproducible color range of the image output apparatus, wherein except for the achromatic line, the one or more second lines are one or more lines situated within the reproducible color range of the image output apparatus.

In the image processing method of the present invention, the first line may be a line extending between white and black, wherein the one or more second lines are one or more lines connecting black with one or more points situated between white and a primary color or a secondary color.

In the image processing method of the present invention, the one or more color material signals allocated on the first and second lines may be one or more signals of same color having different density. Accordingly, a starting point and proportion for a high/low density ink can be suitably determined (allocated).

In the image processing method of the present invention, wherein the one or more color material signals allocated on the first and second lines are one or more signals of black. Accordingly, a starting point and amount of black can be suitably determined (allocated).

In the image processing method of the present invention, the one or more color material signals of black may be allocated to be black starting points at which graininess is unnoticeable. Amount of black can be determined (allocated) in a manner that graininess is more or less unnoticeable.

In the image processing method of the present invention, the one or more color material signals may be allocated according to a designation of a user. Accordingly, color correction (black amount, high/low density ink) can be performed according to a user's preference.

The image processing method of the present invention may further include a step of creating a table indicative of the obtained color material signal corresponding to the input color signal. Accordingly, a table for suitably executing the foregoing image processing method can be created.

An image processing apparatus including: a CPU, wherein the CPU converts an input color signal into a color material signal by referring to the table. Accordingly, an image processing apparatus using a color conversion table for executing the foregoing image processing method can be provided.

An image processing method for converting a color signal, being input to an image output apparatus, into a color material signal, the image processing method including the steps of: defining a first line, defining one or more second lines, defining one or more third lines; allocating one or more color material signals on the first, second, and third lines, and obtaining a color material signal situated between any of the first, second, and third lines by interpolation according to the first, second, and third lines. Accordingly, a color material signal (especially amount of black) can be suitably determined (obtained) for a prescribed range.

In the image processing method of the present invention, the first line may be an achromatic line in a reproducible color range of the image output apparatus, wherein the one or more second lines may be one or more lines situated on an outermost boundary line of the reproducible color range, wherein except for the achromatic line, the one or more third lines may be one or more lines situated within the reproducible color range of the image output apparatus.

In the image processing method of the present invention, the first line may be a line extending between white and black, wherein the one or more second lines may be one or more lines extending between black and a primary color or a secondary color, wherein the one or more third lines may be one or more lines passing through a color range for memory color. Accordingly, amount of black and proportion of high/low density ink for memory color can be controlled separately from colors of other ranges.

In the image processing method of the present invention, the memory color may include human skin color, ocean blue color, sky blue color, and plant green color. Accordingly, amount of black and proportion of high/low density ink can be suitably controlled for memory color such as human skin color, ocean blue color, sky blue color, and plant green color.

In the image processing method of the present invention, the first line is a line extending between white and black, wherein the one or more second lines may be one or more lines extending between black and a primary color or a secondary colors wherein the one or more third lines may be one or more lines connecting black with one or more points situated between white and a primary color or a secondary color.

In the image processing method of the present invention, the one or more color material signals allocated on the first, second, and third lines may be one or more signals of same color having different density. Accordingly, a starting point and proportion for a high/low density ink can be suitably determined (allocated).

In the image processing method of the present invention, the one or more color material signals allocated on the first, second, and third lines may be one or more signals of black. Accordingly, a starting point and amount of black can be suitably determined (allocated).

In the image processing method of the present invention, the one or more color material signals of black allocated on the one or more third lines may be allocated to determine a maximum amount of black for a black signal situated between the first line and the one or more third lines. Accordingly, gray balance at an area proximal to an achromatic axis can be enhanced, amount of ink can be reduced, and amount of black can be determined according to factors such as graininess.

In the image processing method of the present invention, the one or more color material signals of black allocated on the one or more second lines may be allocated to determine a maximum amount of black for the one more color materials of black and obtain a maximum range for the reproducible color range. Accordingly, amount of black can be controlled at an outermost boundary line while maintaining a maximum color range.

In the image processing method of the present invention, the one or more third lines may be controlled according to a characteristic of an input image. Accordingly, amount of black or proportion of high/low density ink can be suitably determined according to a characteristic of an image.

Other objects and further features of the present invention will be apparent from the following detailed description when read in conjunction with the accompanying drawings.

### BRIEF DESCRIPTION OF THE DRAWINGS

FIG. 1 is a block diagram showing a structure of an image processing apparatus according to an embodiment of the present invention;

FIG. 2 is a block diagram showing an exemplary structure of a black generation portion of FIG. 1;

FIG. 3 is a diagram for describing a gamut of an output apparatus;

FIG. 4 is a diagram showing maximum black distribution of black (K′) corresponding to hue H in a CL plane;

FIG. 5 is a diagram showing minimum black distribution of black (K′) corresponding to hue H in a CL plane;

FIG. 6 is an exemplary diagram showing maximum and minimum black situated on a straight line connecting a basing point and a maximum chroma point;

FIG. 7 is a diagram showing a distribution of maximum and minimum black on an x axis extending between the basing point and the maximum chroma point shown in FIG. 6;

FIG. 8 is a diagram showing hue H1 of an input color signal in a CL plane;

FIG. 9 is a diagram for describing a method of designating a black starting point Si(H) according to a basing point and a maximum chroma point;

FIG. 10 is a diagram showing a relation between a black starting point for an input signal Si(H), a black starting point for a red hue Si(HR), and a black starting point for a yellow hue Si(HY).

FIG. 11 is a diagram showing the CH plane in FIG. 10 being converted to an ab plane using Cartesian coordinates;

FIG. 12 is a diagram showing the HL plane of FIG. 10;

FIG. 13 is a block diagram showing a structure of C′M′Y′K′ data conversion portion according to an embodiment of the present invention;

FIG. 14 is a diagram showing an image processing operation according to an embodiment of the present invention;

FIG. 15 is an exemplary diagram showing a hardware structure of an image processing system (image processing apparatus) according to an embodiment of the present invention;

FIG. 16 is a diagram showing a positional relation of primary colors and secondary colors in an a*b* plane;

FIG. 17 is a diagram showing a first line and a second line in a red hue plane in an L*a*b* space;

FIG. 18 is a diagram showing a third line in an L*a*b* space;

FIG. 19 is a diagram for describing a method of determining an amount of black on a first, second, and third line;

FIG. 20 is a diagram for describing a method of obtaining an amount of black situated on an outermost boundary line corresponding to an input color signal with use of interpolation;

FIG. 21 is a diagram for describing a method of obtaining an amount of black situated on an internal line corresponding to an input color signal with use of interpolation;

FIG. 22 is a diagram showing a first line and a second line in a red hue plane in a L*a*b* space;

FIG. 23 is a diagram for describing a method of obtaining an amount of black for a given point P in a L*a*b* space; and

FIG. 24 is a diagram for describing a method of determining an amount of black in a red hue plane in a L*a*b* space.

### DESCRIPTION OF THE PREFERRED EMBODIMENTS

In the following, embodiments of the present invention will be described with reference to the accompanying drawings.

### First Embodiment

(Entire Structure of an Image Processing Apparatus)

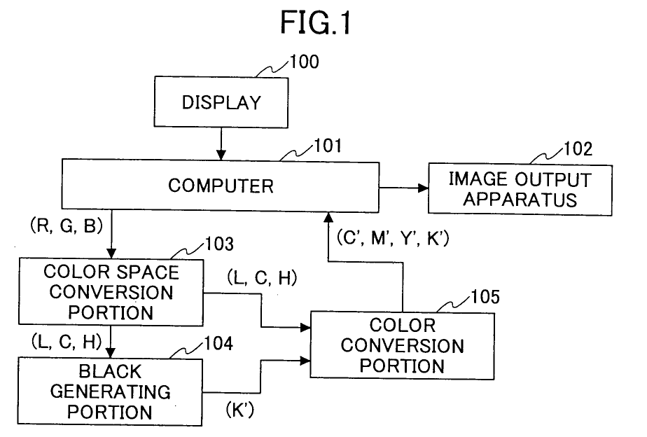

An image processing apparatus according to a first embodiment of the present invention is described below with reference to FIG. 1.

The image processing apparatus may include, for example, a computer 101, an image display apparatus (display) 100 connected to the computer 101, an image output apparatus 102, a color space conversion portion 103 for converting a device-dependent color signal (e.g. RGB signal) from the computer 101 into a device-independent color signal, a black generating portion 104 that computes an amount of black for the image output apparatus 102 by using a result output from the color space conversion portion 103, a color conversion portion 105 serving to obtain remaining color signals (C′, M′, Y′) according to the device-independent color signal and the computed amount of black. The image output apparatus 102 is an output apparatus for printing image data which may include, for example, an image forming apparatus such as a color printer or a color facsimile.

(Operation of the Image Processing Apparatus)

Next, operation of the image processing apparatus of the present invention is described below.

The computer 101 outputs image data included therein by using the image output apparatus 102 to thereby print the image data. This image data comprises color signals including color components of R (Red), G (Green), and B (Blue) typically used for an image displaying apparatus for enabling display. The RGB signals output from the computer 101 are sent to the color space conversion portion 103 and are converted into color signals used by the black generating portion 104. The color signals used by the black generating portion include, but are not to be limited to color components such as lightness (L), chroma (C), and hue (H).

Next, an operation where an LCH space is computed from a CIELab uniform color space is described below.

The black generating portion 104 generates black signals (K′) with a prescribed procedure (procedure described more in detail below). The color conversion portion 105 converts LCH signals and the black signals (K′) into signals (such as C′, M′, Y′) that can be processed by the image output apparatus 102. Then, the converted signals are transmitted to the computer 101.

Next, a method of computing remaining signals of C′, M′, Y′ by using the LCH signals and the computed black signals (K′) is described below.

Device signals of the image output apparatus 102 (C′, M′, Y′, K′) are suitably modified step by step starting from 0 through 255, and then, color patches thereof are output. By measuring the output color patches, LCH signals can be obtained. In other words, a corresponding relation between (C′, M′, Y′, K′) and (L, C, H) can be obtained. It is to be noted that there are various combinations of (C′, M′, Y′, K′) that satisfy a given (L, C, H). Therefore, one of the combinations is extracted by applying a prescribed condition so that a relation where 4 inputs of (C′, M′, Y′, K′) correspond to 3 outputs of (L, C, H) can be obtained.

Next, by converting the relation between (C′, M′, Y′, K′) and (L, C, H) into a relation between (L, C, H, K′) and (C′, M′, Y′), a relation where 4 inputs of (L, C, H, K′) correspond to 3 outputs of (C′, M′, Y′) can be obtained. Finally, by regressing the 4-input-3 input relation and computing the relation between input and output, a single combination of (C′, M′, Y′) can be obtained with respect to any given (L, C, H, K′) combination.

Subsequently, LCH signals and black signals (K′) are converted into signals (such as C′, M′, Y′) so that the signals can be processed by the image output apparatus 102. Then, the converted color signals are transmitted to the image output apparatus 102, to thereby perform printing.

In the example shown in FIG. 1, the color space conversion portion 103 (color space conversion procedure) and the black generating portion 104 (black generating procedure) are illustrated (or performed) separately from the computer 101 and the image output apparatus 102; nevertheless, the color space conversion portion 103 and/or the black generating portion 104 may be installed in the computer 101 and/or in the image output apparatus 102.

The aforementioned procedures may also be executed with software or a program. For example, a printer driver serving as a program in a computer can be used for executing the aforementioned procedures.

(Entire Structure of the Black Generating Portion 104)

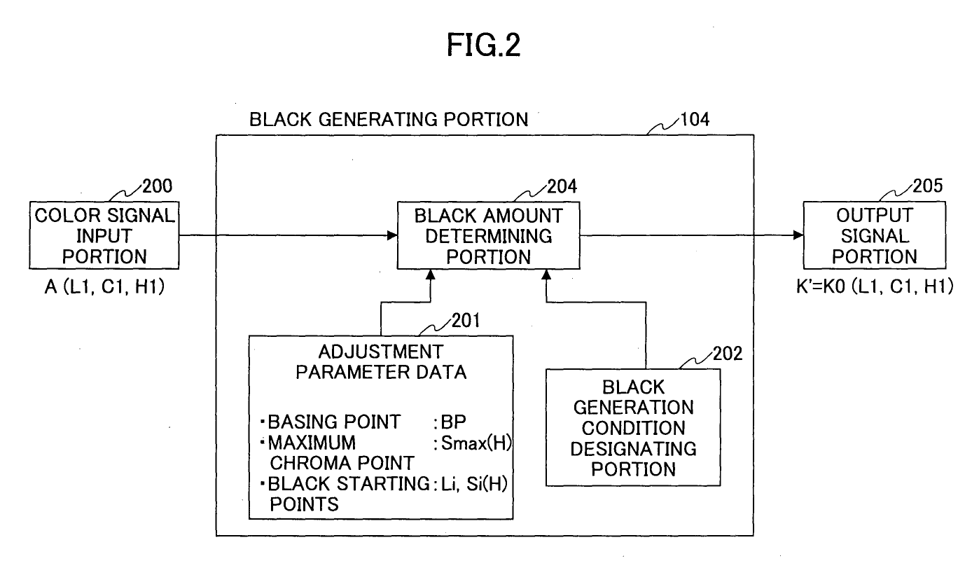

Next, an entire structure of the black generating portion 104 is described below with reference to FIG. 2. The black generating portion 104 may include, for example, a color signal input portion (input unit) 200, a black amount determining portion 204, and an adjustment parameter data 201, a black generation condition (function) designating portion 202, and an output signal portion (output unit) 205.

(Operation of the Black Generating Portion 104)

Next, an operation of the black generating portion 104 is described below.

First, the color signal input portion 200 inputs an input color signal A (L1, C1, H1), which is transmitted from the color space conversion portion 103, to a black amount determining portion 204. The black amount determining portion 204 refers to hue information (data) H1 of the input color signal and selects adjustment parameters according to the hue information H1, such as a maximum chroma point Smax (H1) and a black starting point Si (H1) from adjustment parameter data 201.

Next, a black generating condition(s), which is calculated beforehand, and coordinate information of adjustment parameters of a basing point BP, the maximum chroma point Smax (H1), and the black starting points Li, Si (H1) are input to a black generation condition designating portion 202, to thereby obtain the amount of black by computing K′=Ko (L1, C1, H1). Then, the obtained amount of black is output to the color conversion portion 105 via the output signal portion (output portion) 205.

(Respective Portions of the Black Generating Portion 104)

Next, respective portions of the black generating portion 104 are described below.

(Adjustment Parameter Data 201)

First, adjustment parameter data 201 will be described. The adjustment parameter data 201 may include, for example, 3 elements which are basing point, maximum chroma point, and black starting point (two kinds).

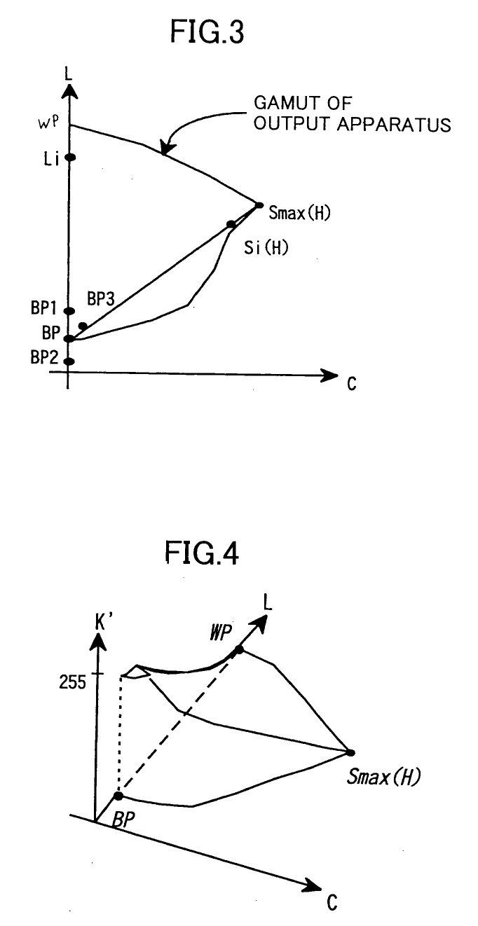

The elements of the adjustment parameter data 201 is described below with reference to FIG. 3.

1) Basing Point: BP

With reference to FIG. 3, the basing point (BP) for generating black is, for example, a Black Point. Nevertheless, a slight deviation of the Black Point has no effect in the precision of generating black. Therefore, a given point in the LCH space (e.g. BP1, BP2, BP3), which is deviated from the Black Point, may also be designated.

2) Maximum Chroma Point: Smax (H)

The maxium chroma point Smax (H) is a point where the value of C is highest on a CL plane. Information regarding the maximum chroma point Smax (H) is employed when designating a black generation function (See FIG. 3).

3) First Black Starting Point: Li

A first black starting point is located on a line connecting the basing point BP and a white point WP. The first black starting point is a point typically located on an achromatic color axis. The first black starting point Li is designated according to a factor leading to degrading of an image (image degrading factor) since the first black starting point is a point that serves to adjust graininess (granularity) and gray balance according to lightness (See FIG. 3).

4) Second Black Starting Point: Si (H)

A second black starting point Si (H) is located on a line connecting the basing point BP and the maximum chroma point Smax(H). The second black starting point Si (H) is designated according to an image degrading factor since the second black starting point is a point that serves to adjust graininess according to chroma and hue (See FIG. 3).

Next, a method of designating the black starting points is described in detail below.

In a case where black is added to a memory color (e.g. skin color, sky color), deterioration of graininess and degrading of image quality may occur. Therefore, in order to avoid these problems, the black starting point is designated so that black cannot be added to a particular color such as the memory color.

Next, the black starting point is designated according to factors such as graininess or gray balance of an output apparatus. For example, black mixed inside a highlight area may not be noticeable in a case where a printer with excellent granularity is used. In this case, Li may be designated proximal to the white point and Si (H) may be designated proximal to the maximum chroma point. In a case where a printer with poor gray balance is used, an achromatic color should preferably be reproduced by increasing black. Therefore, in such a case, Li should preferably be designated with a high value.

Next, a finer adjustment can be executed by further designating Si (H) according to hue.

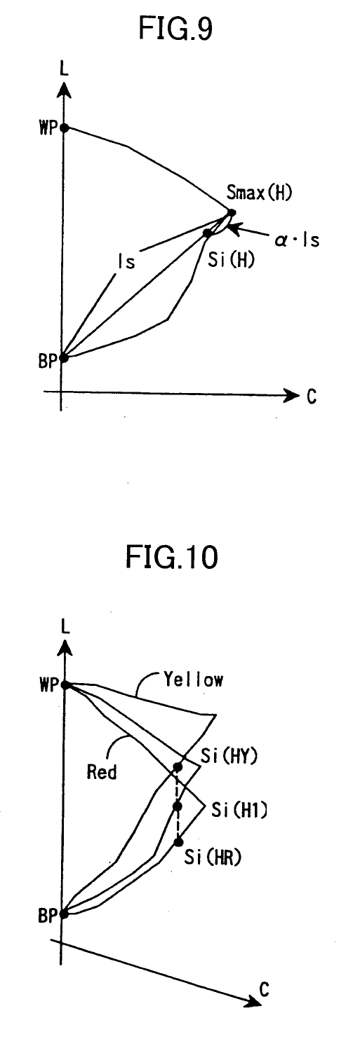

Next, a method for easily designating Si (H) is described with reference to FIG. 9, in which Si (H) is designated according to a length of a line connecting the basing point and the maximum chroma point.

In FIG. 9, the line connecting the basing point and the maximum chroma point is indicated as “ls”. Typically, in terms of a hue having where ls is long, the black starting point should preferably start relatively later since the maximum chroma point thereof tends to be located toward high lightness and high chroma. That is, Si (H) is to be distanced α×ls from the maximum chroma point, wherein 0≦α≦1.

Si (H) may also be determined in correspondence with each hue without having to store Si (H) corresponding to each hue into the adjustment parameter data. This can be achieved by storing Si (H) corresponding to a number of representative hues, and obtaining the other remaining hues by interpolation. This method is described with reference to FIG. 10.

FIG. 10 illustrates a case where hue of an input signal H1 is already obtained supposing that the hue of the input signal H1 is positioned between hues of Red and Yellow.

A black starting point of the Red hue (Si (HR)) is set as (LR, CR, HR) , a black starting point of the Yellow hue (Si(HY)) is set as (LY, CY, HY), and a black starting point of the input signal (Si(H1)) is set as (L1, C1, H1).

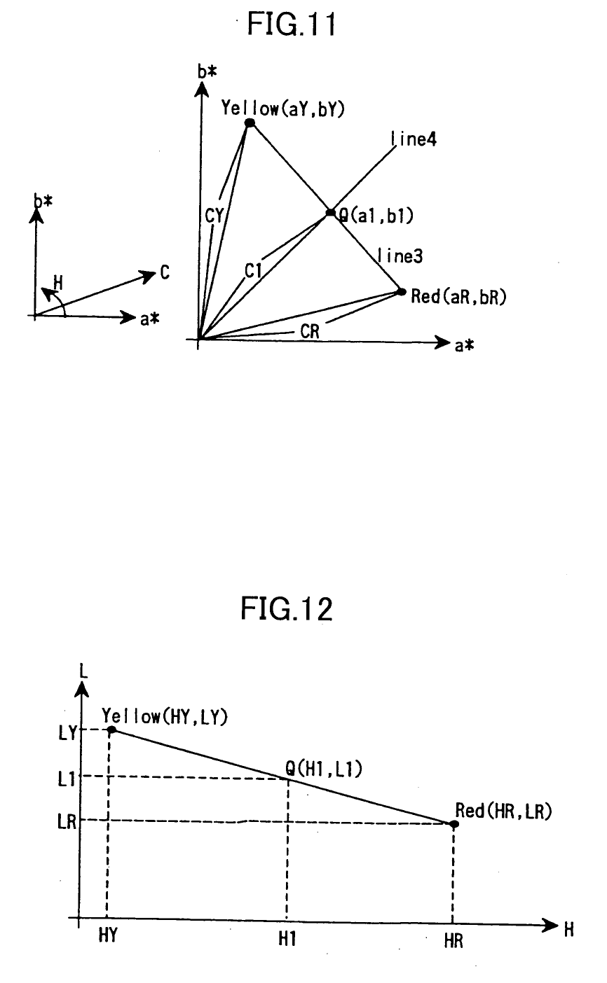

FIG. 11 is a diagram where a CH plane using polar coordinates is converted to an ab plane using Cartesian coordinates. In a case where ab coordinates of Si (HR) are (aR, bR) and the ab values of Si (HY) are (aY, bY), chroma of the input signals (C1) can be computed in a manner given below by using an intersecting point Q (a1, b1) at which a straight line passing through points R and Y (line 3) intersects with a straight line, having a gradient of tan (H1), passing through the origin of the coordinate axes.

aR=CR×cos(HR), bR=CR×sin(HR)

aY=Cy×cos(HY), bY=CY×sin(HY)

line 3: b=γ1×a+β1

γ1={(bY−bR)/(aY−aR)}

β1=bR−{(bY−bR)×aR}/(aY−aR)

line 4: b=η1×a

η1=tan(H1)

a1=−1/(γ1−η1)

b1=−η1×β1/(γ1−η1)

c1={a1\hat{ }2+b1\hat{ }2}\hat{ }(1/2)

FIG. 12 is a diagram showing an HL plane. In a case where HL coordinates of Red is (HR, LR) and HL coordinates of Yellow is (HY, LY), a lightness of the input signals (L1) can be computed in a manner given below by using an intersecting point Q (H1, L1) at which a straight line passing through points R and Y (line 5) intersects with H=H1.

line 5: L=γ2×H+β2

γ2={(LY−LR)/(HY−HR)}

β2=LR−{(LY−LR)×HR}/(HY−HR)

L1=γ2×H1+β2

Among six basic hues (Red, Green, Blue, Cyan, Magenta, Yellow), the above example uses data regarding Red and Yellow. However, other hues besides the six basic hues may also be employed for interpolation. Although the above example employs linear calculation, non-linear calculation or the like may also be employed.

(Black Generation Condition Designating Portion 202)

In the black generation condition designating portion 202, conditions for generating black, which include a black generation function to be used by the black amount determining portion, are determined. The black generation condition designating portion 202 is hereinafter described with reference to FIGS. 4 through 7.

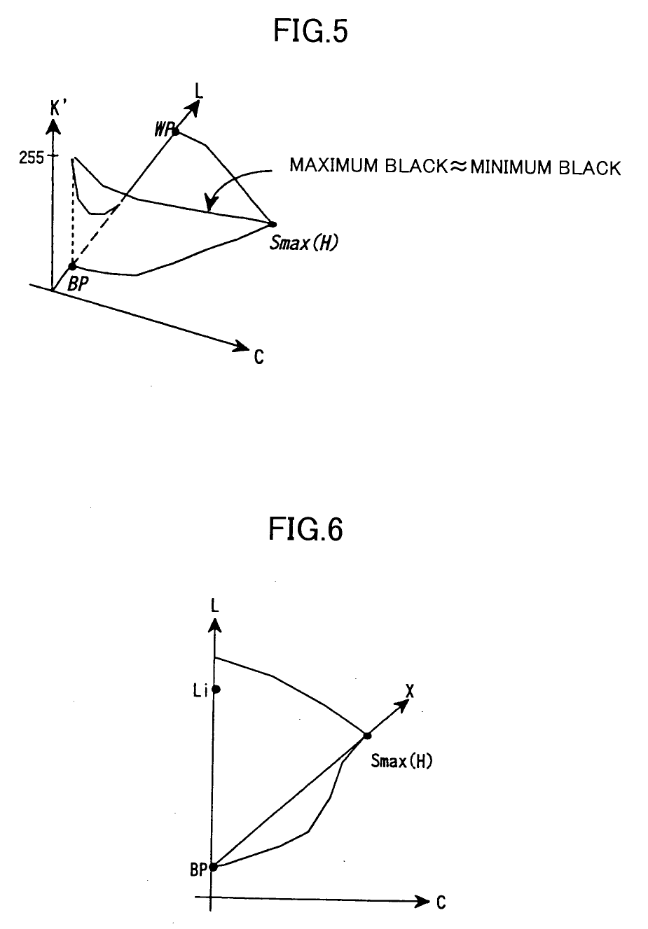

FIGS. 4 and 5 show the amount of black K′ (0 through 255) for a prescribed hue H on a CL plane. K′ in FIG. 4 indicates maximum black, in which maximum black refers to a maximum amount of black that can be added for reproducing the prescribed hue (color). K′ in FIG. 5 indicates minimum black, in which minimum black refers to a minimum amount of black required for reproducing the prescribed hue (color). Therefore, it is preferred that an optimum amount of black for obtaining a wide range gamut is determined by referring to the range of maximum black and minimum black. The maximum amount of black and the minimum amount of black can be obtained by the aforementioned corresponding relation between (C′, M′, Y′, K′) and (L, C, H).

A characteristic of the distribution of maximum black is that the distribution assumes a value of full black (K′=255) at the proximity of the black point (BP), and a value of 0 at high light (i.e. on the line connecting white point (WP) and the maximum chroma point (Smax (H))). Meanwhile, a characteristic of the distribution of minimum black is that the distribution assumes a value of K′=0 at most of the area except for an area proximal to the black point and an area proximal to an outermost border of a shadow portion (i.e. on the line connecting the black point (BP) and the maximum chroma point (Smax (H))).

In addition, the maximum black and the minimum black match at an outermost boundary portion.

Therefore, the width between the maximum black and the minimum black is narrowest at the proximity of the outermost boundary of the shadow portion. In addition, the optimum amount of black is most difficult to determine at the proximity of the outermost boundary of the shadow portion. In this embodiment, the black generation function (f(x)) is computed by using the maximum black and the minimum black on the straight line connecting the basing point and the maximum chroma point shown in FIG. 6. Hue (H0), being employed for this embodiment, is a hue in which the width between the maximum black and the minimum black is narrowest.

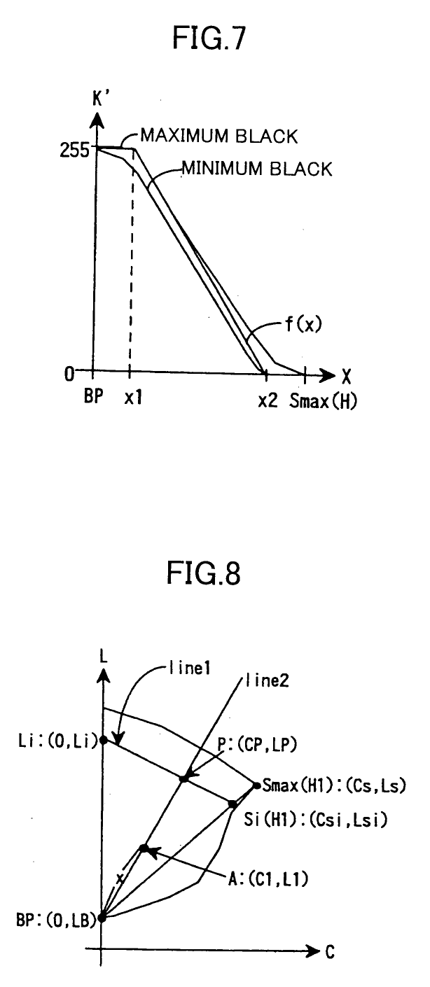

As shown in FIG. 6, an x axis is arranged extending between the basing point and the maximum chroma point. FIG. 7 shows a distribution of the maximum black and the minimum black on the x axis. The black generation function f(x) may be, for example, expressed as the following equation by using the distribution of the maximum black and the minimum black shown in FIG. 7.

f(x)=255, (0≦x<x1)

f(x)=−{255/(x2−x1)}×x+255×x2/(x2−x1), (x1≦x<x2)

f(x)=0, (x2≦x≦x_{—}Smax)

Although f(x) is obtained by connecting the basing point and the maximum chroma point with a straight line, the basing point and the maximum chroma point may also be connected with a curved line.

Furthermore, although this embodiment expresses f(x) as a linear expression, f(x) may also be expressed as, for example, a non-linear expression.

Furthermore, in a case where black is already predetermined to be added in a manner expressible with a linear expression, computation of the above equation will not be required, but merely a black starting point and a terminating point is required to be designated as black generation conditions.

For example, x1 on the x axis may be designated as a black starting point, and x2 may be designated as a black terminating point.

(Black Amount Determining Portion 204)

The black determining portion 204 determines an optimum black amount for an input color signal A (L1, C1, H1) from color signal input portion 200 by referring to the adjustment parameter data 201 and black generation condition of the black generation condition designating portion 202.

An example of computing an optimum black amount is hereinafter described with reference to FIG. 8. FIG. 8 shows a hue of an input signal H1 situated on a CL plane, in which a coordinate for the input signal A is indicated as (C1, L1), a coordinate for a basing point BP is indicated as (0, LB), and coordinates for black starting points Li, Si(H1) are indicated as (0, L1) and (Csi, Lsi).

1) Normalization of Black Generation Function f(x)

First, f(x) is normalized. In a case where the normalized function is fn(xn), fn(xn) may be expressed as an equation given below.

fn(xn)=255, (0≦xn<x1/x_{—}Smax)

fn(xn)=−{255/(x2−x1)}×x+255×x2/(x2−x1), (x1/x_{—}Smax≦xn<x2/x_{—}Smax)

fn(xn)=0, (x2/x_{—}Smax≦xn≦1)

2) Computation of Intersection Point

Then, an intersection point P (CP, LP) between a line 1, which has Li and Si(H1) situated thereon, and a line 2, which has BP and A situated thereon, is computed as given below.

CP=(C1×Csi×Li)/{Csi×L1−C1×(Lsi−Li)

LP=(Csi×Li×L1)/{Csi×L1−C1×(Lsi−Li)}

3) Computation of xn

Then, xn is calculated to be a distance between the basing point BP and a coordinate of input color signal A with respect to a distance between the basing point BP and the intersection point P.

Xn={{C1\hat{ }2+(L1−LB\hat{ }2}\hat{ }(1/2)}/{{CP\hat{ }2+(Li−LP)\hat{ }2}\hat{ }(1/2)}

4) Computation of Optimum Black Amount

Then, xn is substituted for fn(xn) to thereby obtain an optimum black amount K′=Ko (L1, C1, H1) with respect to a desired color (L1, C1, H1).

Ko(L1, C1, H1)=fn(xn)

Furthermore, in a case where a black starting point and a black terminating point are designated as black generation conditions, an optimum black amount is obtained as given below.

Ko(L1, C1, H1)=255×(xn−x1)/x2

### Second Embodiment

(For Achieving a Faster Performance)

In the first embodiment, an optimum amount of black is computed per input color signal. Meanwhile, since an input color signal is converted in a manner where a same amount of black K′ is obtained, there is a one to one relation between an input color signal (L, C, H) and a black amount K′. In addition, as explained in the description regarding the entire structure of the image processing apparatus, there is also a one to one relation between (L, C, H, K′) and (C′,M′, Y′, K′). Therefore, computation can be performed faster if the above corresponding relations are obtained beforehand.

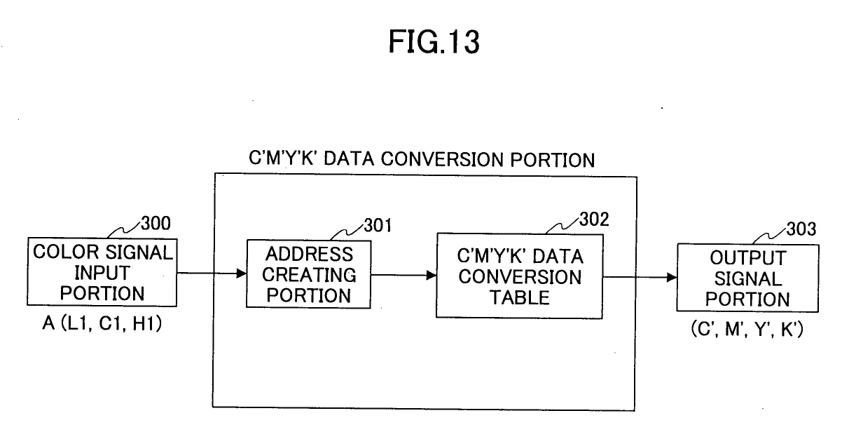

A second embodiment is hereinafter described with reference to FIG. 13. A C′M′Y′K′ data conversion portion according to this embodiment includes an address creating portion 301 and a C′M′Y′K′ data conversion table 302.

In a case where an input color signal A (L1, C1, H1) is input, the address creating portion 301 creates an address for accessing to the C′M′Y′K′ data conversion table 302. The C′M′Y′K′ data conversion table 302 outputs an output C′M′Y′K′ signal 303 (C′M′Y′K′ data) with use of the address output from the address creating portion 301. The output C′M′Y′K′signal 303 (data) is computed in the same manner as the first embodiment.

The C′M′Y′K′ data conversion table 302 is a table indicative of results obtained by executing the black generating portion 104 in the first embodiment with respect to an LCH value having a given step width.

### Third Embodiment

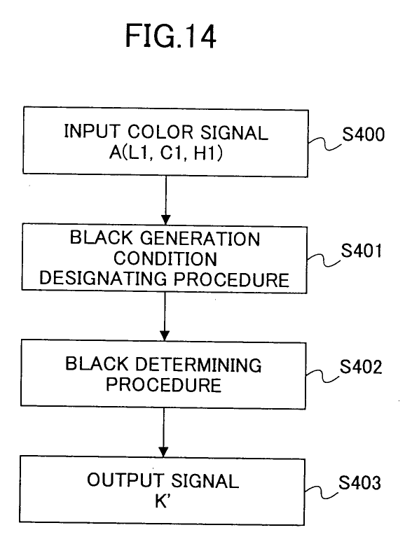

An image processing method using an image processing apparatus is hereinafter described with reference to FIG. 14.

First, a given input color signal A (L1, C1, H1) is input (Step S400). Then, black generation conditions are obtained (Step S401). It is now to be noted that the black generation conditions are designated in the manner described in the aforementioned description regarding the adjustment parameter data 201 and the black generation condition designating portion 202. Next, an optimum black amount K′ is computed (Step S402). The optimum black amount is determined with the black amount determining portion 204. Finally, the optimum black amount K′ is output (Step S404).

### Fourth Embodiment

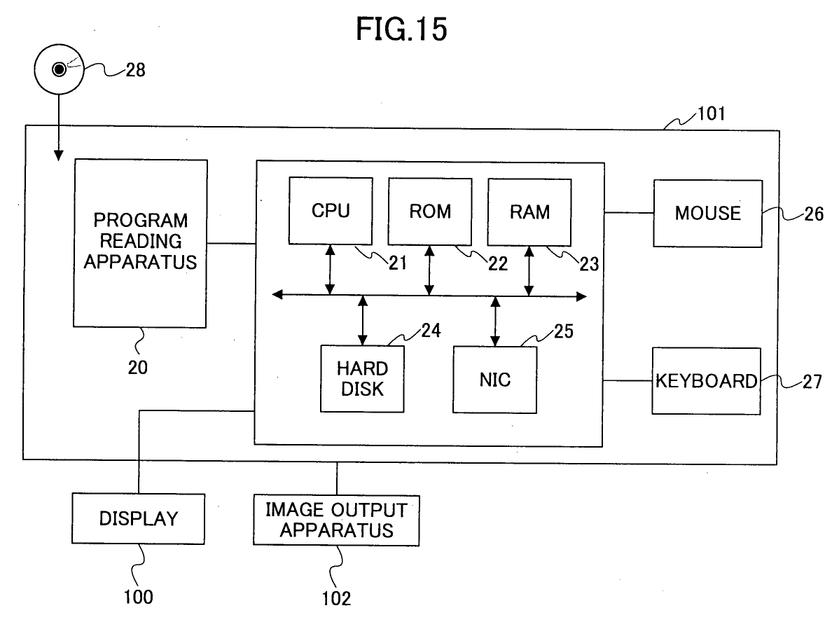

FIG. 15 shows an exemplary hardware structure of the image processing system (image processing apparatus) illustrated in FIG. 1. With reference to FIG. 15, a work station or a personal computer, for example, may be used as the image processing system (image processing apparatus). The image processing system (image processing apparatus) may include: for example, a CPU 21 for controlling the entire system; a ROM 22 having, for example, a control program of the CPU 21 stored therein; a RAM 23 used, for example, as a work area for the CPU 21; a hard disk 24; the display 100 for displaying image data; and the image output apparatus 102 such as a color printer.

The CPU 21, the ROM 22, the RAM 23, the hard disk 24 serve to provide the functions of the computer 101 shown in FIG. 1. The CPU 21 may also serve to provide the functions of the color space conversion portion 103, the black generating portion 104, and the color conversion portion 105. In other words, the CPU 21 may provide the functions of the image processing apparatus according to the embodiment of the present invention.

The functions provided by the CPU 21 may also be provided, for example, in the form of a software package such as an information recording medium 28 (e.g. CD-ROM). The information recording medium may be read, for example, by employing a program reading apparatus 20.

In other words, the image processing apparatus and the image processing method according to the present invention may be provided with use of a typical computer system including a display or the like, by reading a program recorded to an information recording medium, and then enabling a microprocessor thereof to execute the color conversion portion, the black generating portion, and the color conversion portion. In this case, the program for executing the color conversion portion, the black generating portion, and the color conversion portion (program used for the hardware of the image processing system) is provided in a state recorded to the medium. Other than a CD-ROM, the information recording medium having the program recorded thereto may be, for example, a ROM, a RAM, a flexible disk, or a memory card.

The program recorded to the information recording medium 28 may be installed in a memory unit (e.g. hard disk 24) assembled to the hardware system, and executed to thereby provide, for example, the color conversion and the black generation condition designating function.

The program used for executing the functions of the image processing apparatus and the image processing methods may also be provided in the form of communication via a server or the like.

### Fifth Embodiment

The fifth embodiment of the present invention concerns an image processing method for converting input color signals, which are L*a*b* signals in a uniform color space, to four color signals, which include cyan (C), magenta (M), yellow (Y), black (K). It is, however, to be noted that the input signals may also be, for example, RGB signals, or L*u*v* signals.

In the L*a*b* space, an achromatic color line (first line), an outermost boundary line surrounding a color reproduction range of an output apparatus, and an inner line other than the achromatic color line (third line) are defined. In order to define the lines, it is necessary to obtain the color reproduction range of the output apparatus in the L*a*b* space beforehand. Therefore, a printer model anticipating L*a*b* signals expressed by combinations of CMYK is required to thereby grasp the color reproduction range in the L*a*b* space.

Any printer model may be employed as long as a corresponding L*a*b* signal can be computed whenever CMYK is input. There are, for example, a method using a neural network or a method using weighted linear regression (e.g. Japanese Laid-Open Patent Application No.10-262157).

By using the printer model, the color reproduction range can be obtained by computing L*a*b* with respect to every combination of CMYK.

To be more specific, first, a line extending between white (W) and black (K) along a*=b*=0 is defined as the first line. White is the brightest color among the reproducible colors along a*=b*=0, and black is the darkest color among the reproducible colors along a*=b*=0. Although colors brighter than white or colors darker than black generally do exist in a range beyond a*=b*=0, such colors are situated in the proximity of white and black, and have little difference with respect to white and black. Therefore, in this example, colors situated on a*=b*=0 are used.

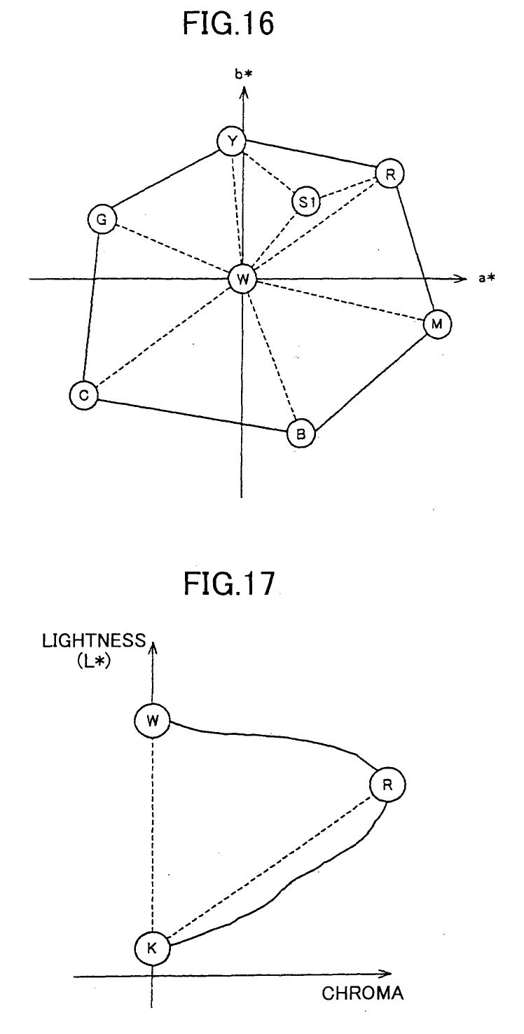

FIG. 16 shows a positional relation between a first color and a second color in an a*b* plane. According to this embodiment of the present invention, a line extending between black and a primary color and/or a secondary color is defined as the second line. In terms of the primary and secondary colors in this embodiment, colors converted as (C,M,Y,K)=(max, 0, 0, 0), (0, max, 0, 0), (0, 0, max, 0), (0, max, max, 0), (max, 0, max, 0) and (max, max, 0, 0) are cyan (C), magenta (M), yellow (Y), red (R), green (G), and blue (B), respectively. The positional relation between the colors are shown in the a*b* plane illustrated in FIG. 16. S1 shown in FIG. 16 will be described below. For simplification, the primary and secondary colors are connected with straight lines to thereby illustrate the outermost boundary line. This line may be determined with use of the printer model.

FIG. 17 is a drawing showing the first line and the second line in a red plane of an L*a*b* space.

Since the primary and secondary colors are typically situated on an outermost boundary line of a color region, the line extending between black and the primary and/or secondary colors may be defined as the second line. If the outermost boundary line is precisely traced, the second line will be a curved line. Nevertheless, the outermost boundary line may be approximated as a straight line. This embodiment is described using with a straight line. FIG. 17 shows the first line and the second line being defined in the red plane. The horizontal axis in FIG. 17 indicate chroma=(a*²+b*²)^{1/2}.

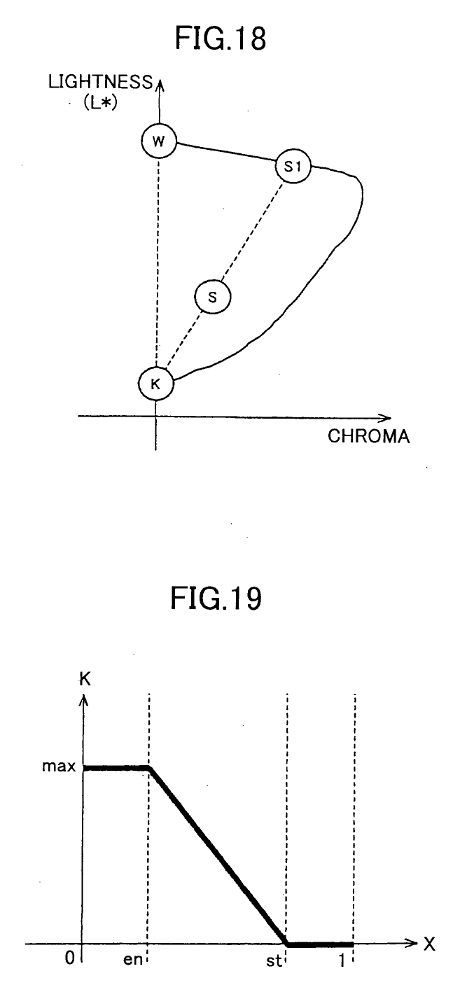

FIG. 18 shows the third line in the L*a*b* space. The third line, in this embodiment, is defined to pass through a color range for reproducing memory color such as human skin color, sky color, and/or plant color. In a case where, human skin color is indicated with a coordinate of, for example, (L*a*b*)=(60, 20, 20), the third line could be defined to pass through the coordinate (See FIG. 18). In this embodiment, the third line is indicated as a straight line S1-K extending between black and skin color point S.

FIG. 19 is a diagram for describing a method of determining the amount of black on the first, second, and third lines.

The amount of black (K) is determined on the first, second, and third lines in the following manner. As shown in FIG. 4, for example, the length for each of the three lines is normalized to 1 so that the amount of black can be determined according to a distance from black (indicated as “x”). Therefore, in this case, the amount of black is 0 when x=1, and the amount of black is maximum value when x=0. Since a black starting point st and a maximum black point en can be determined with different values for each of the lines, an optimum amount of black can be determined for a prescribed range. Although this embodiment determines the amount of black with use of a simple linear function, a non-linear function or the like may also be used. It is, however, to be noted that the amount of black is to be determined to fall within a reproducible color range of a color desired to be reproduced. If the amount of black does not fall within the reproducible color range, a color different from the desired color will be reproduced and the reproducible color range will be narrowed. Particularly, there is no degree of freedom for the amount of black along the outermost boundary line. In other words, the outermost boundary line is defined according to the amount of black. Therefore, the amount of black is to be carefully determined so as to prevent narrowing of the reproducible color range.

One exemplary method for determining the amount of black is a method of determining a black starting point with account for graininess of an output image. To be more specific, this method outputs an image along with altering the black starting point to thereby determine the amount of black at a point where graininess is more or less unnoticeable. In this case, the amount of black for the third line, which passes through a human skin color point, is to be determined more carefully compared to the other lines. This due to the fact that graininess for human skin color tends to be more noticeable compared to other areas. Accordingly, the black starting point for the third line should preferably start later compared to the black starting points for the other lines. That is, determining the lightness of the third line lower than those of the others lines serves to enhance image quality.

Accordingly, by determining the amount of black for each line, an amount of black corresponding to a given input color signal can be obtained through interpolation. For example, in a case where an input color signal corresponding to a point P (L*, a*, b*) is input, hue and chroma are obtained. Then, according to the obtained hue, the input signal is determined to be allocated in the area shown in FIG. 16 being divided into six parts by the primary and secondary colors. For example, if the input signal is determined to be allocated between C and B, the outermost boundary line and the amount of black on the line with respect to the point P is obtained from lines C-K and B-K.

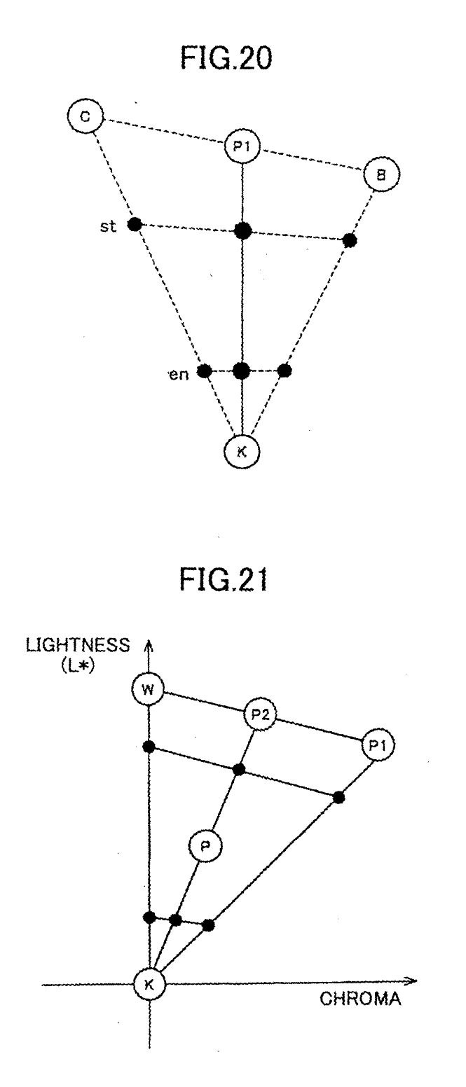

FIG. 20 shows a method for obtaining the amount of black on an outermost boundary line with respect to an input signal by using interpolation. FIG. 21 shows a method for obtaining the amount of black on an internal line by using interpolation.

In FIG. 20, a straight line P1-K at which triangle CBK and hue plane intersect is an outermost boundary line for the hue. A black starting point st for line C-K and a black starting point st for line B-K are connected with a straight line so that an intersecting point between the straight line and line P1-K shall become a black starting point st on line P1-K. A maximum black point en for line C-K and a maximum black point en for line B-K are connected with a straight line so that an intersecting point between the straight line and line P1-K shall become a maximum black point en. With reference to FIG. 21, triangle P1WK is subject to the same procedure to thereby obtain the amount of black on a straight line P2-K. Accordingly, an amount of black of point P situated on the straight line P2-K can be obtained.

Meanwhile, in a case where point P is allocated at a location proximal to human skin color, the procedure for obtaining an amount of black is slightly different from above. In terms of human skin color, the amount of black for human skin color is determined according to a prescribed line S1-K. That is, in a case where point P is determined to be allocated between R and Y in FIG. 16, point P is then determined to be allocated in one of tetrahedrons RYS1K, RWS1K, or YWS1K. Thereafter, an amount of black of point P is obtained in the same manner described above using the amounts of black on three lines connected to a vertex of the designated tetrahedron K. Accordingly, since the amount of black on the S1-K line can be obtained, the amount of black in the human skin color range can be suitably controlled.

After the amount of black is obtained, remaining values for CMY can be obtained in a similar manner using the aforementioned printer model. In this case, however, it is necessary to create a separate printer model and input a value of L*a*b*K* for obtaining CMY.

According to the fifth embodiment of the present invention, an optimum amount of black can be obtained not merely in correspondence to each color but also in correspondence to a color proximal to memory color (e.g. skin color) since the present invention obtains the optimum amount of black by defining amounts of black on an achromatic line, outermost boundary lines for the primary and secondary colors, and memory color line, and then by obtaining the amount of black for a desired color according to the lines.

### Sixth Embodiment

A sixth embodiment according to the present invention also relates to an image processing method which defines an achromatic line in an L*a*b* space (first line), an outermost boundary line (second line), and an internal line except for the achromatic line (third line). The difference between the fifth embodiment and the sixth embodiment is the third line.

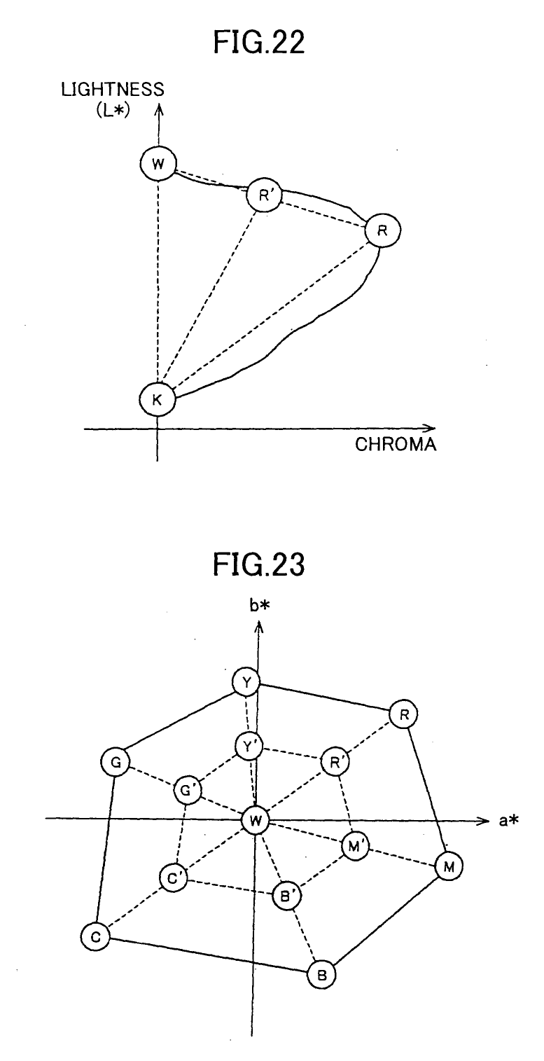

FIG. 22 shows the sixth embodiment where the first and second lines in a red plane in an L*a*b* space. In the sixth embodiment, the third line is defined to be situated between the first line and the second line. That is, in the same manner as the second line, the third line is defined in a same color area as the primary and secondary colors. More specifically, middle points of the lines connecting the primary and secondary colors with white are defined so that each of the lines connecting each of the middle points with black could be defined as the third line. For example in FIG. 22, in a case where a middle point of line W-R is defined as R′, line R′-K is the third line.

FIG. 23 is a diagram for describing a method of obtaining an amount of black for a given point P in an L*a*b* space. In the method for obtaining the amount of black for point P, it is first necessary to determine which of the regions divided with a dotted line in FIG. 23 should point P be located. For example, in a case where point P is located in a tetrahedron region WG′Y′K, the amount of black is computed according to lines W-K, G′-K, and Y′-K. In another case where point P is located in a pentahedron region G′Y′YGK, the amount of black is computed according to lines G′-K, Y′-K, G-K, and Y-K.

By defining internal lines for each of the six hues, the amount of black can be determined more suitably. More specifically, while the outermost boundary line serves to determine the amount of black from the aspect of preventing reduction of color gamut, each of the internal lines serves to determine the amount of black from the aspect of graininess. Therefore, the amount of black can be determined while maintaining a maximum reproducible color gamut and thus obtaining suitable graininess for each hue.

### Seventh Embodiment

A seventh embodiment, in the same manner as the fifth embodiment, defines the third line for each of the six hues. The difference is that each points of C′, M′, Y′, R′, G′, B′ is defined proximal to an achromatic area so that amount of black can be determined for enhancing gray stability. In reproducing achromatic color with inclusion of CMY, slight changes in the performance of an image output apparatus may cause slight changes in the proportion of CMY and may allow unintended colors to appear. Therefore, it is preferable to increase the proportion of K as much as possible so as to enhance gray stability. In addition, increasing the proportion of black provides a benefit of requiring less coloring material. Accordingly, with respect to internal lines defined by points C′, M′, Y′, R′, G′, B′ and K, the amount of black for each of the lines are determined (allocated) so that a large amounts of black can be determined (allocated).

The points C′, M′, Y′, R′, G′, B′ may be defined according to an area desired for enhancement of gray balance. For example, Japanese Laid-Open Patent Application No.2002-185808 describes that an area outlining an achromatic color range may be expressed with a sigmoid function having L*, a*, b* as variables. Therefore, it may be suitable to define the points C′, M′, Y′, R′, G′, B′ by taking such area into consideration.

The seventh embodiment is able to achieve color correction with consideration for gray stability especially at an area proximal to achromatic color and also consideration of factors such as a suitable graininess and/or a broad color gamut at others areas.

### Eighth Embodiment

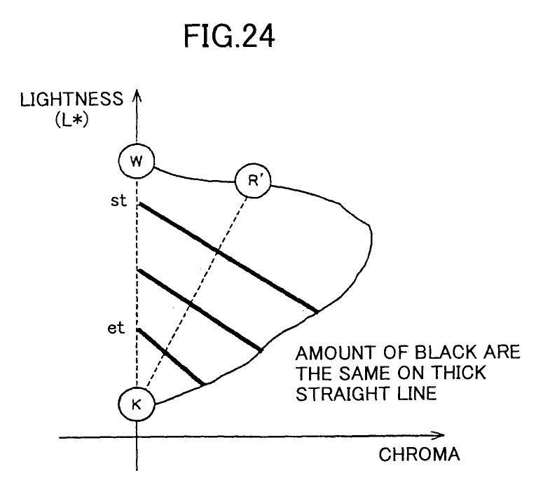

FIG. 24 is a diagram for describing a method of determining an amount of black in a red plane inside an L*, a*, b* space.

Although an image processing method of a eighth embodiment according to the present invention is similar to the image processing method of the sixth embodiment in the fact that internal lines for each hue of the primary and secondary colors are defined, the eighth embodiment has a characteristic of not defining an outermost boundary line. Since poor graininess tend to appear particularly in high light areas, it is more preferable to determine the amount of black for providing suitable graininess by referring to internal lines rather than the outermost boundary line. In respect of the amount of black for a color range outside of an internal line of a hue, a straight line connecting an achromatic line and the internal line can be extended so that points situated on the extended line can be provided with a same amount of black (e.g. FIG. 24 shows an example for determining an amount of black for red).

Accordingly, the amount of black can be determined without having to refer to the outermost boundary line, but instead by simply referring to the achromatic line and the internal line. Therefore, this embodiment allows the amount of black to be determined easier in relation to graininess.

### Ninth Embodiment

Although the image processing methods in embodiments 5 through 8 describe determining the amount of black, the image processing methods may also be effectively employed, for example, in determining the amount of high/low density inks used for printers using six color inks including high/low density inks for cyan and/or magenta.

Since graininess for a dense color ink, similar to black, tends to be noticeable especially at a beginning where the dense color ink is included, color conversion outputting an image with optimum graininess can be performed by suitably determining the amount of the dense color ink at the beginning of the inclusion of the dense color ink. For example, in this case of converting input signals into six colors, the input signals are first converted to four colors of CMYK, and then, C signals and M signals are respectively classified into high/low density inks. Accordingly, the proportion of high/low density inks corresponding to each line can be controlled with respect to the converted C and M inks. For example, since line C-K is an outermost boundary line, the proportion of high density ink for C is 100%. By including a light M ink as color advances from C to K, graininess becomes less noticeable. On the other hand, a dark M ink is included and light M ink is reduced with respect to an area where a color of high density is required.

Accordingly, the amount of high/low density ink can be suitably obtained (determined) for each color area.

### Tenth Embodiment

Although the image processing methods of embodiments 5 to 9 employ L*a*b* signals as input color signals thereof, other signals such as RGB signals may also be employed. For example, each line may be defined in an RGB space for enabling RGB signals to be converted into color material signals; or RGB signals may first be converted into L*a*b* signals, and then each line may be defined in an L*a*b* space for enabling L*a*b* signals to be converted into color material signals. Using a uniform color space such as the L*a*b* space enables color to be controlled in compliance to human senses.

### Eleventh Embodiment

Although various types defining the third line is described above in the image processing methods of embodiments 5 through 7, such types may be selectively employed according to, for example, a characteristic of an image formed by input color signals.

Information (data) regarding the characteristic of the image can be obtained, for example, from a mode preferred (designated) by a user. For example, in a case where text mode is selected, the method of the eighth embodiment for enhancing gray stability may be employed. In a case where photo print mode is selected, the methods of the fifth or sixth embodiments for providing suitable graininess may be employed. In consequence, optimum amount of black can be determined in accordance with the type of image.

Furthermore, header information or the like added to an image for input may also be employed. For example, in a case where an image is obtained with a digital still camera using digital still camera image file format standard (commonly referred to as “Exif”), the image may have header information (e.g. image type of a targeted object or a photography mode) added thereto. By using the header information, factors such as whether the image is a portrait image could be determined. In a case where the image is a portrait image, it may be preferable to employ the method of the fifth embodiment for providing optimum graininess for skin color. In other cases, it may be preferable not to use the third line.

### Twelfth Embodiment

A twelfth embodiment according to the present invention relates to an image processing method and an image processing apparatus which uses a color conversion table. The color conversion table is a table created by executing the methods described in embodiments 5 through 11, in which the table is indicative of input signals corresponding to output signals (color material signals).

The conversion table is not required to indicate every combination of input signals. For example, an input color space may be evenly divided so that color material signals corresponding to prescribed lattice points in the input color signal are obtained. In a case where an input color signal is allocated in between the lattice points, a color material signal corresponding to the input color signal can be obtained by interpolation with use of lattice points proximal to the input color signal. Accordingly, the benefits attained with embodiments 5 through 9 can also be obtained by using the conversion table.

Further, the present invention is not limited to these embodiments, but various variations and modifications may be made without departing from the scope of the present invention.

The present application is based on Japanese priority application Nos.2002-274153 and 2002-346625 filed on Sep. 19, 2002, and Nov. 29, 2002, respectively, with the Japanese Patent Office, the entire contents of which are hereby incorporated by reference.

What is claimed is:

1. An image processing apparatus, comprising:
an input unit inputting a color signal of a color space;
a designating unit designating a color range according to the input color signal;
a black amount determining unit determining an amount of black for the input color signal by referring to a black generation condition corresponding to the designated color range,
wherein the designated color range is a range where a difference between a maximum amount of black and a minimum amount of black is small.

2. The image processing apparatus as claimed in claim 1, wherein the color signal of the color space includes components of lightness, chroma, and hue.

3. The image processing apparatus as claimed in claim 1, wherein the designated color range is situated on a line passing through a basing point and a maximum chroma point, wherein the black generation condition defines a black generation function according to the maximum amount of black and the minimum amount of black of the designated color range.

4. The image processing apparatus as claimed in claim 3, wherein the basing point is a black point.

5. The image processing apparatus as claimed in claim 3, wherein the black generation function is inputted with a value of a distance between the basing point and the input color signal.

6. The image processing apparatus as claimed in claim 1, wherein when a black starting point situated on the line passing through the basing point and the maximum chroma point is Si, and when another black starting point situated on a line passing through the basing point and a white point is Li, the black amount determining unit determines the amount of black according to the black generation condition, and coordinates for the basing point, Si, Li, and the input color signal.

7. The image processing apparatus as claimed in claim 1, wherein the black amount determining unit determines the amount of black by normalizing the black generation function according to the input color signal.

8. The image processing apparatus as claimed in claim 6, wherein Si and Li are designated according to a factor leading to image degrading.

9. The image processing apparatus as claimed in claim 6, wherein Si and Li are designated according to a range of a prescribed color.

10. The image processing apparatus as claimed in claim 6, wherein Si and Li are designated according to a characteristic of an output apparatus.

11. The image processing apparatus as claimed in claim 6, wherein Si is designated according to the hue of the input color signal.

12. The image processing apparatus as claimed in claim 6, wherein Si is designated according to a length of a line connecting the basing point and the maximum chroma point.

13. The image processing apparatus as claimed in claim 6, wherein Si is designated according to black starting point data for hues of Red, Green, Blue, Cyan, Magenta, and Yellow.

14. The image processing apparatus as claimed in claim 8, wherein Si is designated according to the hue of the input color signal.

15. The image processing apparatus as claimed in claim 8, wherein Si is designated according to a length of a line connecting the basing point and the maximum chroma point.

16. The image processing apparatus as claimed in claim 8, wherein Si is designated according to black starting point data for hues of Red, Green, Blue, Cyan, Magenta, and Yellow.

17. The image processing apparatus as claimed in claim 10, wherein Si is designated according to the hue of the input color signal.

18. The image processing apparatus as claimed in claim 10, wherein Si is designated according to a length of a line connecting the basing point and the maximum chroma point.

19. The image processing apparatus as claimed in claim 10, wherein Si is designated according to black starting point data for hues of Red, Green, Blue, Cyan, Magenta, and Yellow.

20. An image processing method comprising the steps of:
a) inputting a color signal of a color space;
b) designating a color range according to the input color signal; and
c) determining an amount of black for the input color signal by referring to a black generation condition corresponding to the designated color range,
wherein the designated color range is a range where a difference between a maximum amount of black and a minimum amount of black is small.

21. An image processing method comprising the steps of:
a) inputting a color signal of a color space;
b) designating a color range according to the input color signal;
c) determining an amount of black for the input color signal by referring to a black generation condition corresponding to the designated color range; and
d) creating a table indicative of the amount of black determined in step c),
wherein the designated color range is a range where a difference between a maximum amount of black and a minimum amount of black is small.

22. A program recorded to be executed with an image processing apparatus, comprising the steps of:
a) inputting a color signal of a color space;
b) designating a color range according to the input color signal; and
c) determining an amount of black for the input color signal by referring to a black generation condition corresponding to the designated color range,
wherein the designated color range is a range where a difference between a maximum amount of black and a minimum amount of black is small.

23. An image processing method for converting a color signal, being input to an image output apparatus, into a color material signal, the image processing method comprising the steps of:
defining a first line;
defining one or more second lines;
allocating one or more color material signals on the first and second lines; and
obtaining a color material signal situated between the first and second lines by interpolation according to the first and second lines.

24. The image processing method as claimed in claim 23, wherein the first line is an achromatic line in a reproducible color range of the image output apparatus, wherein except for the achromatic line, the one or more second lines are one or more lines situated within the reproducible color range of the image output apparatus.

25. The image processing method as claimed in claim 23, wherein the first line is a line extending between white and black, wherein the one or more second lines are one or more lines connecting black with one or more points situated between white and a primary color or a secondary color.

26. The image processing method as claimed in claim 23, wherein the one or more color material signals allocated on the first and second lines are one or more signals of same color having different density.

27. The image processing method as claimed in claim 23, wherein the one or more color material signals allocated on the first and second lines are one or more signals of black.

28. The image processing method as claimed in claim 27, wherein the one or more color material signals of black are allocated to be black starting points at which graininess is unnoticeable.

29. The image processing method as claimed in claim 23, wherein the one or more color material signals are allocated according to a designation of a user.

30. The image processing method as claimed in claim 23, further comprising a step of creating a table indicative of the obtained color material signal corresponding to the input color signal.

31. An image processing apparatus comprising:
a CPU,
wherein the CPU converts an input color signal into a color material signal by referring to the table as set forth in claim 30.

32. An image processing method for converting a color signal, being input to an image output apparatus, into a color material signal, the image processing method comprising the steps of:
defining a first line;
defining one or more second lines;
defining one or more third lines;
allocating one or more color material signals on the first, second, and third lines; and
obtaining a color material signal situated between any of the first, second, and third lines by interpolation according to the first, second, and third lines.

33. The image processing method as claimed in claim 32,
wherein the first line is an achromatic line in a reproducible color range of the image output apparatus, wherein the one or more second lines are one or more lines situated on an outermost boundary line of the reproducible color range, wherein except for the achromatic line, the one or more third lines are one or more lines situated within the reproducible color range of the image output apparatus.

34. The image processing method as claimed in claim 32, wherein the first line is a line extending between white and black, wherein the one or more second lines are one or more lines extending between black and a primary color and/or a secondary color, wherein the one or more third lines are one or more lines passing through a color range for memory color.

35. The image processing method as claimed in claim 34, wherein the memory color includes human skin color, ocean blue color, sky blue color, and plant green color.

36. The image processing method as claimed in claim 32, wherein the first line is a line extending between white and black, wherein the one or more second lines are one or more lines extending between black and a primary color and/or a secondary colors wherein the one or more third lines are one or more lines connecting black with one or more points situated between white and a primary color or a secondary color.

37. The image processing method as claimed in claim 32, wherein the one or more color material signals allocated on the first, second, and third lines are one or more signals of same color having different density.

38. The image processing method as claimed in claim 32, wherein the one or more color material signals allocated on the first, second, and third lines are one or more signals of black.

39. The image processing method as claimed in claim 38, wherein the one or more color material signals of black allocated on the one or more third lines are allocated to determine a maximum amount of black for a black signal situated between the first line and the one or more third lines.

40. The image processing method as claimed in claim 38, wherein the one or more color material signals of black allocated on the one or more second lines are allocated to determine a maximum amount of black for the one more color materials of black and obtain a maximum range for the reproducible color range.

41. The image processing method as claimed in claim 38, wherein the one or more color-material signals of black are allocated to be black starting points at which graininess is unnoticeable.

42. The image processing method as claimed in claim 32, wherein the one or more color material signals are allocated according to a designation of a user.

43. The image processing method as claimed in claim 32, wherein the one or more third lines are controlled according to a characteristic of an input image.

44. The image processing method as claimed in claim 32, further comprising a step of creating a table indicative of the obtained color material signal corresponding to the input color signal.

45. An image processing apparatus comprising:
a CPU,
wherein the CPU converts an input color signal into a color material signal by referring to the table as set forth in claim 44.
